(19) United States
(12) Patent Application Publication
(10) Pub. No.: US 2025/0229181 A1
(43) Pub. Date: Jul. 17, 2025

(54) COMPUTING DIRECTION PARAMETERS OF ROTATING OBJECTS

(71) Applicant: Tencent Technology (Shenzhen) Company Limited, Shenzhen (CN)

(72) Inventors: Jinfeng YE, Shenzhen (CN); Hao FU, Shenzhen (CN)

(73) Assignee: Tencent Technology (Shenzhen) Company Limited, Shenzhen (CN)

(21) Appl. No.: 19/096,275

(22) Filed: Mar. 31, 2025

Related U.S. Application Data
(63) Continuation of application No. PCT/CN2023/129574, filed on Nov. 3, 2023.

(30) Foreign Application Priority Data
Feb. 21, 2023 (CN) 202310186576.0

(51) Int. Cl. A63F 13/577

(52) U.S. Cl. CPC A63F 13/577; A63F 2300/643

(57) ABSTRACT

In a data processing method, a first direction parameter and a rotation angular velocity of a target object in a first game frame, and an inter-frame interval duration between the first game frame and a second game frame are obtained. The second game frame is rendered after the first game frame. A target rotation angle of the target object is obtained based on the rotation angular velocity and the inter-frame interval duration. A second direction parameter of the target object in the second game frame is determined based on the target rotation angle and the first direction parameter. Apparatus and non-transitory computer-readable storage medium counterpart embodiments are also contemplated.

### RELATED APPLICATIONS

The present application is a continuation of International Application No. PCT/CN2023/129574, filed on Nov. 3, 2023, which claims priority to Chinese Patent Application No. 202310186576.0, filed on Feb. 21, 2023. The entire disclosures of the prior applications are hereby incorporated by reference.

### FIELD OF THE TECHNOLOGY

This application relates to the field of Internet technologies, including a data processing method.

### BACKGROUND OF THE DISCLOSURE

An object in a rotating state usually exists in a game scene. During rendering of a game frame that includes a rotating object, a direction parameter of the rotating object needs to be calculated in real time, and the game frame is obtained by rendering the rotating object based on the direction parameter of the rotating object. It has been found in practice that a current manner of calculating the direction parameter of the rotating object is prone to a problem of data overflow, resulting in a game interruption.

### SUMMARY

Aspects of this disclosure include a data processing method, an apparatus, and a non-transitory computer-readable storage medium, which can avoid data overflow and a game interruption caused by the data overflow. Examples of technical solutions of this disclosure may be implemented as follows:

An aspect of this disclosure provides a data processing method. A first direction parameter and a rotation angular velocity of a target object in a first game frame, and an inter-frame interval duration between the first game frame and a second game frame are obtained. The second game frame is rendered after the first game frame. A target rotation angle of the target object is obtained based on the rotation angular velocity and the inter-frame interval duration. A second direction parameter of the target object in the second game frame is determined based on the target rotation angle and the first direction parameter.

An aspect of this disclosure provides an apparatus. The apparatus includes processing circuitry configured to obtain a first direction parameter and a rotation angular velocity of a target object in a first game frame, and an inter-frame interval duration between the first game frame and a second game frame. The second game frame is rendered after the first game frame. The processing circuitry is configured to obtain a target rotation angle of the target object based on the rotation angular velocity and the inter-frame interval duration. The processing circuitry is configured to determine a second direction parameter of the target object in the second game frame based on the target rotation angle and the first direction parameter.

An aspect of this disclosure provides a non-transitory computer-readable storage medium storing instructions which when executed by a processor cause the processor to perform any of the methods of this disclosure.

In this disclosure, to enable a physics engine to represent an initial direction parameter (i.e., a first direction parameter of a rotating object in the first game frame), an inter-frame interval duration, and a rotation angular velocity of the rotating object (i.e., the target object), the initial direction parameter, the inter-frame interval duration, and the rotation angular velocity all fall within a range of numerical values controllable by the physics engine. When the initial direction parameter of the rotating object needs to be updated, the computer device may perform indexation processing on the rotation angular velocity of the rotating object by using the inter-frame interval duration between every two game frames (the first game frame and the second game frame), to obtain the target rotation angle of the target object. It may be learned based on the principle of the indexation processing that the indexation processing is equivalent to performing processing such as cosine calculation and sine calculation on a product of the rotation angular velocity and the inter-frame interval duration. It may be learned that indexation processing is performed on the rotation angular velocity by using the inter-frame interval duration, so that the target rotation angle obtained through the indexation processing can be limited in the range of numerical values controllable by the physics engine. Further, the updated direction parameter (i.e., the second direction parameter) of the rotating object that is determined and obtained based on the target rotation angle and the initial direction parameter of the rotating object also falls within the range of numerical values controllable by the physics engine. In other words, the updated direction parameter can be represented by the physics engine in the computer device, so as to avoid data overflow and a game interruption caused by the data overflow, thereby improving smoothness of the game.

### BRIEF DESCRIPTION OF THE DRAWINGS

FIG. 1 is a schematic diagram of a direction parameter determination system according to this disclosure.

FIG. 2 is a schematic diagram of an interaction scene of a data processing method according to this disclosure.

FIG. 3 is a schematic flowchart of a data processing method according to this disclosure.

FIG. 4 is a schematic flowchart of a data processing method according to this disclosure.

FIG. 5 is a schematic structural diagram of a data processing apparatus according to an aspect of this disclosure.

FIG. 6 is a schematic structural diagram of a computer device according to an aspect of this disclosure.

### DETAILED DESCRIPTION

Technical solutions in aspects of this disclosure are described in the following with reference to the accompanying drawings. The described aspects are merely some rather than all of the aspects of this disclosure. Other aspects obtained by a person of ordinary skill in the art based on the aspects of this disclosure shall fall within the scope of this disclosure.

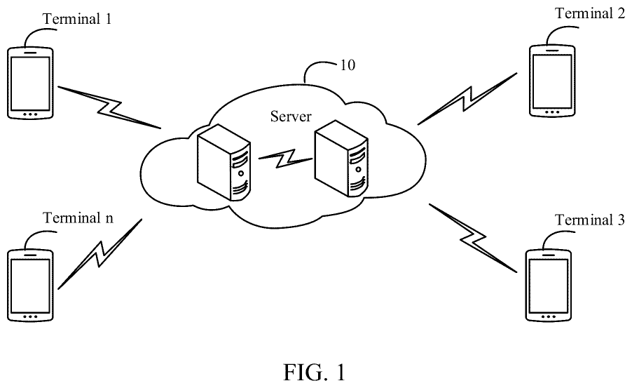

For ease of understanding of this disclosure, a direction parameter determination system implementing this disclosure is first described. As shown in FIG. 1, the direction parameter determination system includes a server 10 and a terminal cluster. The terminal cluster may include one or more terminals. A quantity of the terminals is not limited herein. As shown in FIG. 1, the terminal cluster may specifically include a terminal 1, a terminal 2, . . . , and a terminal n. The terminal 1, the terminal 2, the terminal 3, . . . , and the terminal n may be connected to the server 10 through a network, so that each terminal can exchange data with the server 10 through the network connection.

One or more target applications are installed in the terminal. The target application herein may be a game application. For example, the target application may include an independent application, a web application, a mini program in a host application, or the like.

The server 10 is a device providing a back-end service to the target application in the terminal. In an aspect, the server may be configured to: obtain a direction parameter of a rotating object, obtain a game frame through rendering based on the direction parameter, and return the game frame to the terminal.

In this disclosure, the rotating object may be a rigid body in a physics engine. The rigid body refers to an object that does not deform and is rotatable and movable. In other words, the rotating object may refer to a game object that does not deform and is rotatable and movable in a game scene. For example, the game object may include a game character (such as a virtual character, a virtual animal, or a virtual robot), and a game prop (such as a virtual ferris wheel or a virtual frisbee). The physics engine may refer to a computer software development kit that calculates motion, rotation, and collision by assigning the rotating object real physical properties. The physics engine may be deployed in a terminal, or may be deployed in a server, and the physics engine belongs to a functional module in a game engine.

In the physics engine, numerical values such as a direction parameter and a rotation angle of the rotating object may be represented by using a fixed-point number-based representation method or a floating-point number-based representation method. In the fixed-point number-based representation method, when a decimal is stored in a computer device, a position of a decimal point for the decimal is defined and fixed, an integer part and a fractional part of the decimal are respectively converted into binary representations, and a sum of a quantity of bits representing the fractional part and a quantity of bits representing the integer part is not to exceed a quantity of bits of the computer device. For example, in an 8-bit computer device, it is stipulated that first 5 bits represent an integer part of a decimal, last 3 bits represent a fractional part, and a decimal point is a position after a fifth bit by default. In this case, in the 8-bit computer device, an integer part 11111 can only represent a maximum decimal number of 31. A fractional part 0.111 can only represent a maximum decimal number of 0.875. To be specific, a range of numerical values that may be represented in the 8-bit computer device is [0, 31.875].

The floating-point number-based representation method means that a number having an unfixed position of a decimal point has both a fractional part and an integer part. In the computer device, a floating-point number is usually divided into two parts: a characteristic (also referred to as an exponent) and a mantissa. The characteristic is represented by a binary fixed-point integer, and the mantissa is represented by a binary fixed-point decimal. A length of the characteristic determines a range of numerical values, and a length of the mantissa determines precision of a numerical value. For example, in a 16-bit computer device, 178.125 in decimal may be converted into 10110010 001 in binary, 10110010 representing an integer part of 178.125, and 001 representing a fractional part of 178.125. Alternatively, 178.125 in decimal may also be represented as 10110010001 multiplied by 2 to the power 111 (111 is a binary representation of 7), 10110010001 being a mantissa of 178.125, and 111 being a characteristic of 178.125.

It may be learned that the floating-point number-based representation method has diversified representation forms, and has a relatively wide range of numerical values that may be represented. The fixed-point number-based representation method has a fixed representation form, and may be applied to a cross-platform data synchronization scene. The cross-platform data synchronization scene refers to a scene of data synchronization performed between game applications running in different operating systems. For example, a game application a is run in an Android system of a terminal a. The terminal a corresponds to a game character a, and the game application a is run in an IOS system of a terminal b. The terminal a may display a game frame 1 including the game character a, obtain operation data of a game player for the game character a, and synchronize the operation data to the terminal b. The terminal a and the terminal b may respectively determine a rotation angular velocity of the game character a based on the operation data, obtain an inter-frame interval duration between the game frame 1 and a game frame 2 and a first direction parameter of the game character a in the game frame 1, and update the first direction parameter based on the rotation angular velocity and the inter-frame interval duration, to obtain a second direction parameter of the game character a in the game frame 2. The terminal a and the terminal b both represent the second direction parameter of the game character in the game frame 2 in a fixed-point number-based representation manner. Due to the fixed representation form of the fixed-point number-based representation method, the second direction parameters obtained by the terminal a and the terminal b are the same. In this way, it may be ensured that motions of the game characters displayed by the terminal a and the terminal b can be kept consistent. In addition, this may avoid synchronizing a large number of object states (such as a direction parameter and a rotation angular velocity) between different terminals, which may save traffic. In other words, the fixed-point number-based representation method may ensure consistency of data in the cross-platform data synchronization scene.

In other words, the computer device may select a numerical representation method of the physics engine based on whether a game scene has a cross-platform data synchronization requirement. For example, in a multiplayer online game application, a corresponding terminal between different game players is usually needed to synchronize data. Therefore, it may be determined that the multiplayer online game application has the cross-platform data synchronization requirement. In this case, the computer device may determine the fixed-point number-based representation method as the numerical representation method of the physics engine. In an offline game application, a corresponding terminal between the game players is usually not needed to synchronize data. Therefore, it may be determined that the offline game application has no cross-platform data synchronization requirement. In this case, the computer device may determine the fixed-point number-based representation method or the floating-point number-based representation method as the numerical representation method of the physics engine.

This disclosure mainly relates to a game scene. The game scene may be a cloud gaming scene or an ordinary game scene. The cloud gaming scene is a game scene based on cloud gaming. The cloud gaming may also be referred to as gaming on demand, and is an online game scene technology based on a cloud computing technology. The cloud gaming technology enables a light client with relatively limited graphic processing and data computing capabilities to run a high-quality game. In the cloud gaming scene, a game is run on a cloud server (i.e., a game scene server) rather than a game terminal of a player, and the cloud server renders the game scene into a video and audio stream, and transmits the video and audio stream to a player game terminal (i.e., a terminal) through the network. The game terminal of the player is not required to have powerful graphics computing and data processing capabilities, but only required to have a basic streaming media playback capability and a capability of obtaining an instruction inputted by the player and transmitting the instruction to the cloud server. The ordinary game scene may be a game scene in which a game is run in a terminal.

The server may be an independent physical server, or may be a server cluster or a distributed system formed by at least two physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may specifically be an on-board terminal, a smart phone, a tablet computer, a notebook computer, a desktop computer, a smart speaker, a screen speaker, a smart watch, or the like, but is not limited thereto. Each terminal and the server may be directly or indirectly connected through wired or wireless communication. In addition, one or at least two terminals and servers may be provided, which is not limited in this disclosure.

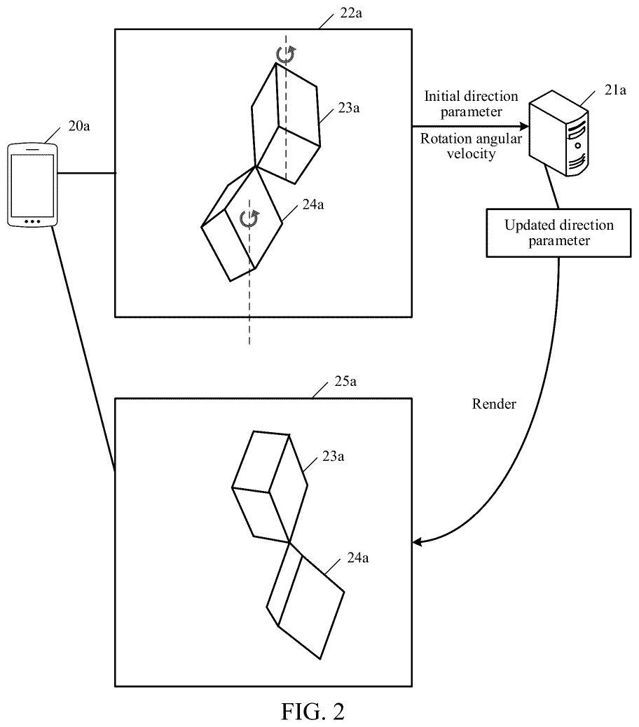

The direction parameter determination system in FIG. 1 may be applied to determine the direction parameter of the rotating object in the game scene. Specifically, as shown in FIG. 2, a terminal 20a in FIG. 2 may be any terminal in the terminal cluster in FIG. 1, and a server 21a in FIG. 2 may be the server 10 in FIG. 1. A game frame 22a is displayed in the terminal 20a. The game frame 22a includes an object 23a and an object 24a. Shapes of the object 23a and the object 24a are both cuboids, the object 23a and the object 24a are both rotating objects, and rotation directions of the object 23a and the object 24a are both from left to right. The terminal 22a may respectively obtain a rotation angular velocity, a first direction parameter, and an inter-frame interval duration of the object 23a and the object 24a, and may transmit, to the server 21a, the rotation angular velocity, the first direction parameter, and the inter-frame interval duration that respectively correspond to the object 23a and the object 24a. The inter-frame interval duration is an interval duration between the game frame 22a and a next game frame 25a thereof. The first direction parameter of the object 23a reflects an orientation of the object 23a in the game frame 22a. In other words, the first direction parameter of the object 23a reflects an included angle between the object 23a and each of an X axis, a Y axis, and a Z axis at a first moment. The first direction parameter of the object 24a reflects an orientation of the object 24a in the game frame 22a. In other words, the first direction parameter of the object 24a reflects an included angle between the object 24a and each of an X axis, a Y axis, and a Z axis at a first moment. The first moment is a display moment of the game frame 22a.

Further, the server 21a may perform indexation processing on the rotation angular velocity of the object 23a based on the inter-frame interval duration by using a physics engine, to obtain a target rotation angle of the object 23a, and perform indexation processing on the rotation angular velocity of the object 24a based on the inter-frame interval duration by using the physics engine, to obtain the target rotation angle of the object 24a. Herein, to enable the physics engine to represent the rotation angular velocity, the first direction parameter, and the inter-frame interval duration that respectively correspond to the object 23a and the object 24a, the rotation angular velocity, the first direction parameter, and the inter-frame interval duration that respectively correspond to the object 23a and the object 24a all fall within a controllable range of numerical values of the physics engine. Performing indexation processing on the rotation angular velocity of the object 23a based on the inter-frame interval duration is equivalent to performing processing such as cosine processing and sine processing on a product between the inter-frame interval duration and the rotation angular velocity of the object 23a. In other words, the target rotation angle of the object 23a obtained through the indexation processing falls within the controllable range of numerical values of the physics engine. Similarly, performing indexation processing on the rotation angular velocity of the object 24a based on the inter-frame interval duration is equivalent to performing processing such as cosine processing and sine processing on a product between the inter-frame interval duration and the rotation angular velocity of the object 24a. In other words, the target rotation angle of the object 24a obtained through the indexation processing falls within the controllable range of numerical values of the physics engine. In other words, intermediate values (i.e., the target rotation angles of the object 23a and the object 24a) in a process of obtaining updated direction parameters of the object 23a and the object 24a do not exceed the controllable range of numerical values of the physics engine, so that overflow of the intermediate values can be avoided.

Then, the server 21a may determine, based on the target rotation angle and the first direction parameter of the object 23a by using the physics engine, a second direction parameter of the object 23a in the game frame 25a, and determine, based on the target rotation angle and the first direction parameter of the object 24a by using the physics engine, the second direction parameter of the object 24a in the game frame 25a. The second direction parameter of the object 23a herein reflects an orientation of the object 23a at a second moment. In other words, the second direction parameter of the object 23a reflects an included angle between the object 23a and each of the X axis, the Y axis, and the Z axis at the second moment. The second direction parameter of the object 24a reflects an orientation of the object 24a at the second moment. In other words, the second direction parameter of the object 24a reflects an included angle between the object 24a and each of the X axis, the Y axis, and the Z axis at the second moment. The second moment is a display moment of the game frame 25a. After obtaining the second direction parameters respectively corresponding to the object 23a and the object 24a, the server 21a may perform collision detection on the object 23a and the object 24a based on position information of the object 23a and the object 24a at the second moment. In other words, if the object 23a and the object 24a have the same position at the second moment, it is determined that the object 23a and the object 24a collide with each other. In this case, the second direction parameters respectively corresponding to the object 23a and the object 24a may be adjusted, to obtain third direction parameters respectively corresponding to the object 23a and the object 24a. The object 23a is rendered based on the third direction parameter corresponding to the object 23a, and the object 24a is rendered based on the third direction parameter corresponding to the object 24a, to obtain the game frame 25a. If the object 23a and the object 24a have different positions at the second moment, it is determined that the object 23a and the object 24a do not collide with each other. In this case, the object 23a may be rendered based on the second direction parameter corresponding to the object 23a, and the object 24a may be rendered based on the second direction parameter corresponding to the object 24a, to obtain the game frame 25a. The server 21a, after obtaining the game frame 25a, may transmit the game frame 25a to the terminal 20a, and update the game frame 22a displayed by the terminal 20a to the game frame 25a.

Based on the above, the target rotation angle and the first direction parameter of the object 23a both fall within the controllable range of numerical values of the physics engine, and the second direction parameter of the object 23a also falls within the controllable range of numerical values of the physics engine. Since the target rotation angle and the first direction parameter of the object 24a both fall within the controllable range of numerical values of the physics engine, the second direction parameter of the object 24a also falls within the controllable range of numerical values of the physics engine. In other words, the intermediate value in the process of obtaining the updated direction parameters (i.e., the second direction parameter) of the object 23a and the object 24a, and the finally obtained updated direction parameter do not exceed the controllable range of numerical values of the physics engine, so that data overflow and a game interruption caused by the data overflow can be avoided, smoothness of the game can be improved, and extremely high precision of the updated direction parameter can further be ensured.

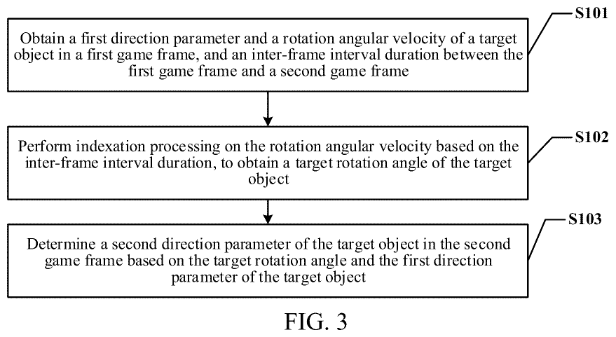

Further, FIG. 3 is a schematic flowchart of a data processing method according to an aspect of this disclosure. As shown in FIG. 3, the method may be performed by any terminal in the terminal cluster in FIG. 1, or may be performed by the server in FIG. 1. Devices configured to perform the data processing method in this disclosure may be collectively referred to as computer devices. The method may include the following operations.

S101: Obtain a first direction parameter and a rotation angular velocity of a target object in a first game frame, and an inter-frame interval duration between the first game frame and a second game frame, a rendering order of the second game frame being after a rendering order of the first game frame. For example, a first direction parameter and a rotation angular velocity of a target object in a first game frame, and an inter-frame interval duration between the first game frame and a second game frame are obtained. The second game frame is rendered after the first game frame.

In this disclosure, the target object may refer to a rotating object in a game scene. The computer device may obtain the first direction parameter and the rotation angular velocity of the target object in the first game frame, and the inter-frame interval duration between the first game frame and a second game frame. The first direction parameter is configured for reflecting an orientation of the target object in the first game frame. In other words, the first direction parameter of the target object reflects included angles between the target object and an X axis, a Y axis, and a Z axis at a first moment. The first moment is a display moment of the first game frame. The X axis, the Y axis, and the Z axis belong to a Cartesian coordinate system of a space in which the target object is located. The rotation angular velocity may be a speed at which the target object rotates along a point in space. The inter-frame interval duration may reflect how long the computer device displays the second game frame after the first game frame is displayed. In other words, the second game frame may be a next frame of the first game frame.

If the first game frame is a first game frame including the target object, the first direction parameter of the target object in the first game frame may be an initial direction parameter of the target object. The initial direction parameter of the target object may be formulated by a game rule of a game application to which the first game frame belongs, or the initial direction parameter of the target object may be a direction parameter of the target object when the computer device closes the game application last time. The rotation angular velocity of the target object may be determined based on operation data (for example, a force exerted on the target object) of a game player corresponding to the computer device in the game application. The operation data may be synchronized to the computer device by another device. Alternatively, the rotation angular velocity of the target object may be formulated based on the game rule of the game application to which the first game frame belongs. The foregoing inter-frame interval duration may be formulated based on the game rule of the game application to which the first game frame belongs.

To enable the physics engine corresponding to the first game frame to represent the first direction parameter, the rotation angular velocity, and the inter-frame interval duration, the first direction parameter, the rotation angular velocity, and the inter-frame interval duration all fall within a controllable range of numerical values. The controllable range of numerical values may be determined based on a quantity of bits of the computer device and a numerical representation method in of the physics engine. For example, it is assumed that the numerical representation method of the physics engine is a fixed-point number-based representation method, the quantity of bits of the computer device is 8 bits, and it is agreed in the physics engine that first 5 bits represent an integer part of a decimal, last 3 bits represent a fractional part, and a decimal point is a position after a fifth bit by default, a range of numerical values that may be represented in an 8-bit computer device is [0, 31.875]. In other words, a controllable range of numerical values herein is [0, 31.875]. Certainly, it may also be agreed in the physics engine that a first 1 bit represents an integer part of a decimal, and last 7 bits represent a fractional part of a decimal. In this case, the range of numerical values that can be represented by the 8-bit computer device is [0, 1.9921875]. In other words, in this case, the controllable range of numerical values is [0, 1.9921875]. For another example, it is assumed that the numerical representation method in the physics engine is a floating-point number-based representation method, the quantity of bits of the computer device is 8 bits, and a range of numerical values that can be represented in the 8-bit computer device is [−126, 127]. In other words, in this case, the controllable range of numerical values is [−126, 127].

S102: Perform indexation processing on the rotation angular velocity based on the inter-frame interval duration, to obtain a target rotation angle of the target object. For example, a target rotation angle of the target object is obtained based on the rotation angular velocity and the inter-frame interval duration.

In this disclosure, the computer device may perform indexation processing on the rotation angular velocity based on the inter-frame interval duration, to obtain the target rotation angle of the target object. Herein, the indexation processing may refer to performing exponential operation processing on the inter-frame interval duration and the rotation angular velocity. It may be learned based on a Euler formula corresponding to the exponential operation processing (in other words, it may be learned based on an indexation processing principle) that the indexation processing is equivalent to performing processing such as cosine calculation the sine calculation on a product of the rotation angular velocity and the inter-frame interval duration. Because results obtained through performing cosine and sine processing all fall within a range of [−1, −1], the indexation processing is performed on the rotation angular velocity based on the inter-frame interval duration, and the target rotation angle of the target object that is obtained also falls within a controllable range of numerical values.

In some aspects, indexation processing is performed on the rotation angular velocity based on the inter-frame interval duration, to obtain the target rotation angle of the target object. The rotation angular velocity of the target object includes rotation angular velocities w1, w2, and w3 respectively corresponding to the target object on the X axis, the Y axis, and the Z axis. The X axis, the Y axis, and the Z axis may belong to a Cartesian coordinate system of a space in which the target object is located. The computer device may convert the rotation angular velocity of the target object into a three-dimensional angular velocity vector of the target object. To be specific, the three-dimensional angular velocity vector of the target object may be represented as \vec{w}=[w1, w2, w3]. The computer device may determine the three-dimensional rotation angle vector of the target object based on a product of the three-dimensional angular velocity vector and the inter-frame interval duration. For example, the computer device may determine half of the product of the three-dimensional angular velocity vector and the inter-frame interval duration as the three-dimensional rotation angle vector of the target object. Alternatively, the product of the three-dimensional angular velocity vector and the inter-frame interval duration is determined as the three-dimensional rotation angle vector of the target object. Further, the computer device may perform indexation processing on the three-dimensional rotation angle vector of the target object, to obtain a quaternion rotation angle vector of the target object. The quaternion rotation angle vector is a vector that represents a rotation angle of the target object based on a quaternion. The quaternion rotation angle vector of the target object is determined as the target rotation angle of the target object. The rotation angle (i.e., the target rotation angle) of the target object is represented based on the quaternion, which may improve efficiency of determining the rotation angle of the target object, save storage space, and avoid a gimbal lock phenomenon.

The quaternion includes a real number and three imaginary units i, j, and k, which have the following relationship: i^{2.}−j^{2.}=k^{2.}=−1, and i⁰=j⁰=k⁰=1. Each quaternion is a linear combination of 1, i, j, and k. To be specific, the quaternion may be represented as a+bi+cj+dk, a, b, c, and d being real numbers. The geometrical meaning of i, j, and k may be understood as a rotation. A rotation i represents a rotation angle of the target object from a positive direction of the Z axis to a positive direction of the Y axis in a plane where the Z axis intersects with the Y axis, a rotation j represents a rotation angle of the target object from a positive direction of the X axis to the positive direction of the Z axis in a plane where the X axis intersects with the Z axis, and a rotation k represents a rotation angle of the target object from the positive direction of the Y axis to the positive direction of the X axis in a plane where the Y axis intersects with the X axis.

A representation manner of the rotation angle of the target object includes a quaternion-based manner, a matrix rotation manner, and a Euler rotation manner. If the rotation angle of the target object is represented in the quaternion-based manner, only four elements (i.e., a, b, c, and d) are needed to represent the rotation angle of the target object, and the target object does not need to rotate based on a rotation sequence of a fixed coordinate axis. For example, the rotation sequence of the fixed coordinate axis may be the X axis first, then the Y axis, and finally the Y axis. For the matrix rotation manner, during calculation of the rotation angle of the target object, a transformation matrix (i.e., the transformation matrix has 16 elements) rotating about any axis needs to be represented by using a matrix having a size of 4*4, and the rotation angle of the target object is calculated based on a product of the transformation matrix and the rotation angular velocity. For the Euler rotation manner, the target object needs to rotate based on the rotation sequence of the fixed coordinate axis. It may be learned that for the quaternion-based manner, fewer elements are needed. To be specific, the rotation angle of the target object is represented in the quaternion-based manner, which may improve efficiency of determining the rotation angle of the target object and save storage space. For the quaternion-based manner, the target object does not need to rotate based on the rotation sequence of the fixed coordinate axis. To be specific, the rotation angle of the target object is represented in the quaternion-based manner, which may avoid the gimbal lock phenomenon. The gimbal lock phenomenon herein may mean that during rotation of the target object based on the rotation sequence of the fixed coordinate axis, if some coordinate axes are accidentally overlapped, the target object loses the ability to rotate in a direction in this case. In other words, in this state, no matter how the target object rotates (certainly, an original coordinate axis rotation sequence still needs to be followed), the target object cannot obtain some desired rotation effects, unless the original coordinate axis rotation sequence is disrupted or 3 coordinate axes are simultaneously rotated.

In some aspects, the performing indexation processing on the three-dimensional rotation angle vector of the target object to obtain a quaternion rotation angle vector of the target object includes: performing, by the computer device, padding for the three-dimensional rotation angle vector of the target object, to obtain a four-dimensional rotation angle vector, for example, adding a zero to supplement the three-dimensional rotation angle vector of the target object, to obtain the four-dimensional rotation angle vector; and performing an operation with the four-dimensional rotation angle vector as an exponent and a natural constant as a base, to obtain the quaternion rotation angle vector of the target object, where the natural constant herein may refer to e.

For example, the computer device may represent the three-dimensional rotation angle vector of the target object by using the following Equation (1):

$$\vec{v} = \frac{1}{2} \vec{ω} Δ t \qquad ( 1 )$$

In Equation (1), \vec{ω} represents the three-dimensional rotation angular velocity of the target object, Δt represents the inter-frame interval duration between the first game frame and the second game frame, and \vec{v} represents the three-dimensional rotation angle vector of the target object. 0 is added to the three-dimensional rotation angle vector of the target object, to obtain the four-dimensional rotation angle vector of the target object, which may be represented as [\vec{v} 0]. Further, the operation with the four-dimensional rotation angle vector as an exponent and a natural constant as a base is performed, to obtain the quaternion rotation angle vector of the target object. To be specific, the quaternion rotation angle vector of the target object may be represented as exp([\vec{v} 0]), exp representing a natural constant e.

In some aspects, based on a Euler's formula of the exponent, that the operation with the four-dimensional rotation angle vector as an exponent and a natural constant as a base is performed, to obtain the quaternion rotation angle vector of the target object includes the following. The computer device may perform modulo processing on the four-dimensional rotation angle vector, to obtain a real number angle of the target object. For example, the computer device may calculate a sum of squares of elements in the four-dimensional rotation angle vector, and then perform a square root operation on the sum of squares of elements, to obtain the real number angle of the target object. To be specific, the real number angle may be represented as |[\vec{v} 0]|. Since 0 does not affect a magnitude of the real number angle, |[\vec{v} 0]| may be equivalent to |\vec{v}|.

Further, the computer device may perform unitization processing on the four-dimensional rotation angle vector, to obtain a unit four-dimensional rotation angle vector. For example, a ratio of the four-dimensional rotation angle vector to the real number angle is determined as the unit four-dimensional rotation angle vector. To be specific, the unit four-dimensional rotation angle vector may be represented as

$$\frac{[ \begin{matrix}\vec{v} & 0\end{matrix} ]}{\vert \vec{v} \vert} .$$

The computer device may determine a product of the unit four-dimensional rotation angle vector and a sine value of the real number angle as a candidate rotation angle of the target object. To be specific, the candidate rotation angle of the target object may be represented as

$$\frac{[ \begin{matrix}\vec{v} & 0\end{matrix} ]}{\vert \vec{v} \vert}$$

sin|\vec{v}|, and then may determine a sum of the candidate rotation angle of the target object and a cosine value of the real number angle as the quaternion rotation angle vector of the target object.

For example, the quaternion rotation angle vector of the target object may be expressed by using the following Equation (2):

$$exp ( [ \begin{matrix}\vec{v} & 0\end{matrix} ] ) = cos \vert \vec{v} \vert + \frac{[ \begin{matrix}\vec{v} & 0\end{matrix} ]}{\vert \vec{v} \vert} sin \vert \vec{v} \vert = cos \vert \vec{v} \vert + \frac{\vec{v}}{\vert \vec{v} \vert} sin \vert \vec{v} \vert \qquad ( 2 )$$

where a specific form of expression of exp([\vec{v} 0]) is a+bi+cj+dk.

S103: Determine a second direction parameter of the target object in the second game frame based on the target rotation angle and the first direction parameter of the target object. For example, a second direction parameter of the target object in the second game frame is determined based on the target rotation angle and the first direction parameter.

In this disclosure, the computer device, after obtaining the target rotation angle of the target object and the first direction parameter, may determine the second direction parameter of the target object in the second game frame based on the target rotation angle of the target object and the first direction parameter. The second direction parameter may refer to an orientation of the target object in the second game frame. In other words, the second direction parameter of the target object reflects included angles between the target object and the X axis, the Y axis, and the Z axis at the second moment. The second moment is a display moment of the second game frame. Because the target rotation angle and the first direction parameter both belong to a controllable range of numerical values, the second direction parameter obtained based on the target rotation angle and the first direction parameter also belongs to a controllable range of numerical values, so as to avoid problems such as data overflow and a game interruption, thereby improving smoothness of the game.

The computer device renders the target object based on the second direction parameter after the second direction parameter is obtained through calculating, to obtain a second game frame including the target object. Further, when the game application to which the first game frame belongs is a multiplayer online game application, the computer device may synchronize the second direction parameter to another device. The another device may include a device corresponding to a game player belonging to the same game battle team as the target game player and a device corresponding to a game player belonging to an enemy battle team corresponding to the target game player. The target game player is a game player corresponding to the computer device.

In some aspects, the determining a second direction parameter of the target object in the second game frame based on the target rotation angle and the first direction parameter of the target object includes: generating a first quaternion direction vector reflecting the first direction parameter of the target object. In other words, the first quaternion direction vector is a vector representing the first direction parameter of the target object based on the quaternion. If the first direction parameter of the target object is a three-dimensional direction vector, a zero is added to supplement the three-dimensional direction vector, to obtain the first quaternion direction vector. Further, a product of the first quaternion direction vector and the quaternion rotation angle vector corresponding to the target rotation angle is determined as a second quaternion direction vector of the target object in the second game frame. The second quaternion direction vector may be a vector that represents a direction parameter of the target object in the second game frame based on the quaternion. The second quaternion direction vector is determined as the second direction parameter of the target object in the second game frame.

For example, the computer device may represent the second direction parameter of the target object in the second game frame by using the following Equation (3):

$$q = exp ( [ \begin{matrix}\vec{v} & 0\end{matrix} ] ) ⊗ {q}_{0} \qquad ( 3 )$$

In Equation (3), q₀ represents the first quaternion direction vector. q is a second quaternion direction vector, namely, the second direction parameter of the target object in the second game frame. ⊗ represents the product of two vectors. Based on the foregoing Equation (2), Equation (3) may be equivalent to the following Equation (4):

$$q = exp ( [ \begin{matrix}\vec{v} & 0\end{matrix} ] ) ⊗ {q}_{0} = [ cos \vert \vec{v} \vert + \frac{\vec{v}}{\vert \vec{v} \vert} sin \vert \vec{v} \vert ] ⊗ {q}_{0} \qquad ( 4 )$$

It may be learned based on Equation (4) that, when the direction parameter of the target object is represented by using a quaternion-based manner in the physics engine, direction parameters based on the quaternion all fall within the controllable range of numerical values of the physics engine. In other words, each value of q₀ is in the controllable range of numerical values of the physics engine. A magnitude of \vec{v} is jointly determined by \vec{ω} and Δt. \vec{ω} is designed with a magnitude limit, for example, \vec{ω} is within the controllable range of numerical values of the physics engine.

It is assumed that calculated \vec{v} is a maximum value within the controllable range of numerical values of the physics engine, results of the three calculations of cos|\vec{v}|, sin|\vec{v}|, and \vec{v}/|\vec{v}| are all less than \vec{v}. In other words, results of the three calculations of cos|\vec{v}|, sin|\vec{v}|, and \vec{v}/|\vec{v}| do not exceed the controllable range of numerical values of the physics engine. In other words, the physics engine can also perform the three calculations of cos|\vec{v}|, sin|\vec{v}|, and \vec{v}/|\vec{v}|. Then, results of the three calculations of cos|\vec{v}|, sin|\vec{v}|, and \vec{v}/|\vec{v}| are in a range of [−2, 2). cos|v|+\vec{v}/|\vec{v}|sin|\vec{v}| is a complex addition calculation, and an obtained result is also in a range of [−2, 2). Because each value of q₀ in is within the controllable range of numerical values of the physics engine, [cos|\vec{v}|+\vec{v}/|\vec{v}|sin|\vec{v}|]⊗q₀ belongs to the controllable range of numerical values. To be specific, the second direction parameter of the target object does not exceed the controllable range of numerical values of the physics engine, and intermediate values (i.e., cos|\vec{v}|+\vec{v}/|\vec{v}|sin|\vec{v}|, cos|\vec{v}|, sin|\vec{v}|, and \vec{v}/|\vec{v}|) in a calculation process of the second direction parameter of the target object do not exceed the controllable range of numerical values of the physics engine.

In other words, such a manner of determining the second direction parameter of the target object can avoid problems such as data overflow and a game interruption, and ensure high precision of the direction parameter.

For example, a description is provided by using an example in which the controllable range of numerical values of the physics engine is [−2, 2). Therefore, the first direction parameter, the second direction parameter, and the intermediate values (i.e., cos|\vec{v}|+\vec{v}/|\vec{v}|sin|\vec{v}|, cos|\vec{v}|, sin|\vec{v}|, and \vec{v}/|\vec{v}|) of the foregoing target object are all in a range of [−2, 2).

In other words, because the first direction parameter, the second direction parameter, and an integer part of the intermediate values are relatively small, when the physics engine represents a value (for example, the direction parameter) based on a fixed-point number, the physics engine may use a smaller quantity of bits to represent the integer part, and use a larger quantity of bits to represent the fractional part, thereby improving precision of obtaining the direction parameter of the target object. For example, a 32-bit computer device may use 1 bit to represent a positive or negative numerical value, 30 bits to represent a fractional part of the numerical value, and 1 bit to represent an integer part of the numerical value. In this way, the computer device may use more bits to represent the fractional part of the value, thereby improving precision of the value (the first direction parameter and the second direction parameter).

In an aspect, after the second direction parameter is obtained, an orientation of a rigid body (the target object) in the game may be set to q. Collision detection is performed by using a newly obtained orientation, and then collision and constraint solving are performed. An application layer performs some application-specific functions by using the solved orientation, and may directly modify an orientation just mentioned.

In this disclosure, to enable a physics engine to represent an initial direction parameter (i.e., a first direction parameter of a rotating object in the first game frame), an inter-frame interval duration, and a rotation angular velocity of the rotating object (i.e., the target object), the initial direction parameter, the inter-frame interval duration, and the rotation angular velocity all fall within a range of numerical values controllable by the physics engine. When the initial direction parameter of the rotating object needs to be updated, the computer device may perform indexation processing on the rotation angular velocity of the rotating object by using the inter-frame interval duration between every two game frames (the first game frame and the second game frame), to obtain the target rotation angle of the target object. It may be learned based on the principle of the indexation processing that the indexation processing is equivalent to performing processing such as cosine calculation and sine calculation on a product of the rotation angular velocity and the inter-frame interval duration. It may be learned that indexation processing is performed on the rotation angular velocity by using the inter-frame interval duration, so that the target rotation angle obtained through the indexation processing can be limited in the range of numerical values controllable by the physics engine. Further, the updated direction parameter (i.e., the second direction parameter) of the rotating object that is determined and obtained based on the target rotation angle and the initial direction parameter of the rotating object also falls within the range of numerical values controllable by the physics engine. In other words, the updated direction parameter can be represented by the physics engine in the computer device, so as to avoid data overflow and a game interruption caused by the data overflow, thereby improving smoothness of the game.

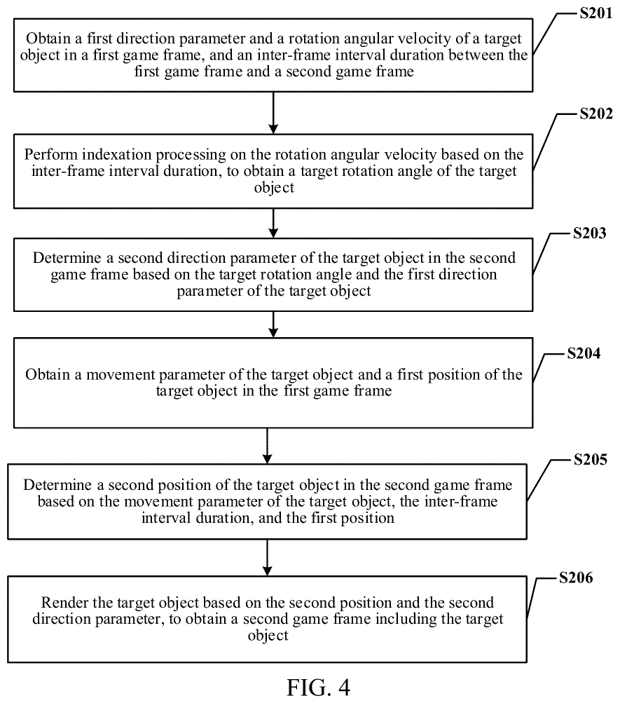

Further, FIG. 4 is a schematic flowchart of a data processing method according to an aspect of this disclosure. As shown in FIG. 4, the method may be performed by any terminal in the terminal cluster in FIG. 1, or may be performed by the server in FIG. 1. Devices configured to perform the data processing method in this disclosure may be collectively referred to as computer devices. The method may include the following operations.

S201. Obtain a first direction parameter and a rotation angular velocity of a target object in a first game frame, and an inter-frame interval duration between the first game frame and a second game frame, a rendering order of the second game frame being after a rendering order of the first game frame. For example, a first direction parameter and a rotation angular velocity of a target object in a first game frame, and an inter-frame interval duration between the first game frame and a second game frame are obtained. The second game frame is rendered after the first game frame.

S202: Perform indexation processing on the rotation angular velocity based on the inter-frame interval duration, to obtain a target rotation angle of the target object. For example, a target rotation angle of the target object is obtained based on the rotation angular velocity and the inter-frame interval duration.

S203: Determine a second direction parameter of the target object in the second game frame based on the target rotation angle and the first direction parameter of the target object. For example, a second direction parameter of the target object in the second game frame is determined based on the target rotation angle and the first direction parameter.

In this disclosure, for explanations and descriptions of operation S201, reference may be made to the foregoing explanations and descriptions of operation S101. For explanations and descriptions of operation S202, reference may be made to the foregoing explanations and descriptions of operation S102. For explanations and descriptions of operation S203, reference may be made to the foregoing explanations and descriptions of operation S103. Repeated parts are not described again.

S204: Obtain a movement parameter of the target object and a first position of the target object in the first game frame. For example, a movement parameter of the target object and a first position of the target object in the first game frame are obtained.

S205: Determine a second position of the target object in the second game frame based on the movement parameter of the target object, the inter-frame interval duration, and the first position. For example, a second position of the target object in the second game frame is obtained based on the movement parameter, the inter-frame interval duration, and the first position.

In some aspects, that a second position of the target object in the second game frame is determined based on the movement parameter of the target object, the inter-frame interval duration, and the first position includes the following. The computer device may determine a product of a movement speed in the movement parameter and the inter-frame interval duration as a movement distance of the target object, and determine the second position of the target object in the second game frame based on a movement direction in the movement parameter, the movement distance, and the first position. For example, the first position is (x, y, z) cm, x, y, and z respectively representing coordinate values of the target object in an x axis, a y axis, and a z axis. If the movement direction of the target object is a positive direction of the x axis, and the movement distance is 3 cm, the second position of the target object in the game frame is (x+3, y, z) cm.

S206: Render the target object based on the second position and the second direction parameter, to obtain the second game frame including the target object. For example, the target object is rendered based on the second position and the second direction parameter to obtain the second game frame including the target object.

In operation S204 to operation 206, the computer device may obtain the movement parameter of the target object based on a game rule of a game application to which the first game frame belongs, or obtain the movement parameter of the target object based on operation data of a game player corresponding to the computer device for the target object in the first game frame. The movement parameter may include a movement direction, a movement speed, and the like. The computer device may obtain a display position of the target object in the first game frame, and use the display position as the first position of the target object. Further, the computer device determines the display position of the target object in the second game frame based on the movement parameter of the target object, the inter-frame interval duration, and the first position, and determines the display position of the target object in the second game frame as the second position of the target object in the second game frame. The target object is rendered based on the second position and the second direction parameter, to obtain the second game frame including the target object. Particularly, the movement speed of the target object may be 0, and a position of the target object is not moved. In other words, the first position of the target object in the first game frame is the same as the second position of the target object in the second game frame.

In some aspects, that the target object is rendered based on the second position and the second direction parameter, to obtain a second game frame including the target object includes the following. If one target object is provided, the computer device may directly render the target object based on the second position and the second direction parameter, to obtain the second game frame including the target object. If at least two target objects are provided, the computer device may perform collision detection on the at least two target objects based on the second position corresponding to each of the at least two target objects, to obtain a detection result. For example, the at least two target objects include a first target object and a second target object. If second positions respectively corresponding to the first target object and the second target object are the same, a detection result indicating that the first target object and the second target object collide is generated. If the second positions respectively corresponding to the first target object and the second target object are different, a detection result indicating that the first target object and the second target object do not collide is generated. Further, the second direction parameter corresponding to each of the at least two target objects are adjusted based on the detection result, to obtain a third direction parameter corresponding to each of the at least two target objects. The at least two target objects are rendered based on the third direction parameter and the second position corresponding to each of the at least two target objects, to obtain the second game frame including the at least two target objects.

That the second direction parameter corresponding to each of the at least two target objects are adjusted based on the detection result, to obtain a third direction parameter corresponding to each of the at least two target objects includes the following. If the detection result indicates that the first target object and the second target object in the at least two target objects do not collide with each other, the second direction parameter of the first target object is determined as the third direction parameter of the first target object, and the second direction parameter of the second target object is determined as the third direction parameter of the second target object. If the detection result indicates that the first target object and the second target object in the at least two target objects collide with each other, an object category of the first target object and an object category of the second target object are obtained. The object category includes a virtual person, a virtual prop, and the like. The second direction parameter of the first target object is adjusted based on the object category of the first target object and the object category of the second target object, to obtain the third direction parameter of the first target object. For example, a game rule specifies an adjustment rule of a direction parameter of a corresponding object after collision between different object categories. The computer device may query the game rule for the adjustment rule of the direction parameter of the first target object based on the object category of the first target object and the object category of the second target object, and adjust the second direction parameter of the first target object based on the adjustment rule of the direction parameter of the first target object, to obtain the third direction parameter of the first target object. Similarly, the adjustment rule of the direction parameter of the second target object is queried from the game rule based on the object category of the first target object and the object category of the second target object, and the second direction parameter of the second target object is adjusted based on the adjustment rule of the direction parameter of the second target object, to obtain the third direction parameter of the second target object.

After the first target object collides with the second target object, whether the second positions of the first target object and the second target object change is determined based on the game rule. If the game rule stipulates that the second positions of the first target object and the second target object change, the computer device may respectively adjust the second positions corresponding to the first target object and the second target object based on the game rule, to obtain third positions respectively corresponding to the first target object and the second target object. Based on the third direction parameter and the third position respectively that respectively correspond to the first target object and the second target object, the first target object and the second target object are rendered, to obtain the second game frame including the first target object and the second target object. If the game rule stipulates that the second positions of the first target object and the second target object do not change, the computer device may render the first target object and the second target object based on the third direction parameter and the second position that respectively correspond to the first target object and the second target object, to obtain the second game frame including the first target object and the second target object.

In this disclosure, after obtaining the second direction parameter of the target object, the computer device may obtain the position of the target object in the second game frame, and render the target object based on the second direction parameter of the target object and the position of the target object in the second game frame, to obtain the second game frame including the target object. Data overflow and a game interruption caused by the data overflow can be avoided, thereby improving smoothness of the game.

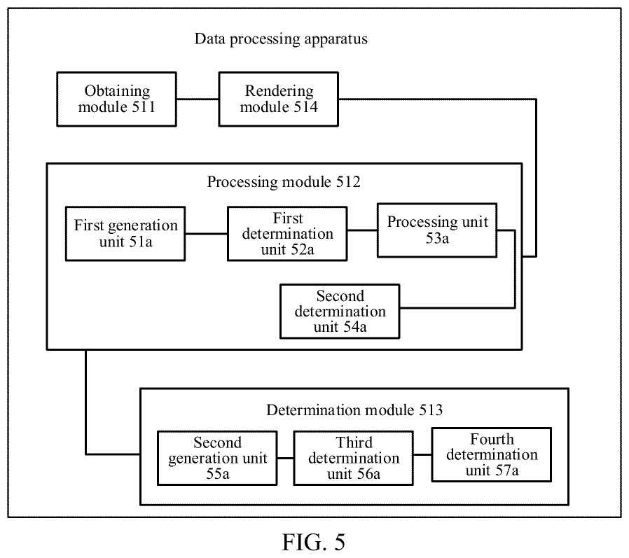

FIG. 5 is a schematic structural diagram of a data processing apparatus according to an aspect of this disclosure. As shown in FIG. 5, the data processing apparatus may include:
an obtaining module 511, configured to obtain a first direction parameter and a rotation angular velocity of a target object in a first game frame, and an inter-frame interval duration between the first game frame and a second game frame, a rendering order of the second game frame being after a rendering order of the first game frame;
a processing module 512, configured to perform indexation processing on the rotation angular velocity based on the inter-frame interval duration, to obtain a target rotation angle of the target object; and
a determination module 513, configured to determine a second direction parameter of the target object in the second game frame based on the target rotation angle and the first direction parameter of the target object.

In some aspects, the processing module 512 includes a first generation unit 51a, a first determination unit 52a, a processing unit 53a, and a second determination unit 54a.

The first generation unit 51a is configured to generate a three-dimensional angular velocity vector of the target object based on the rotation angular velocity.

The first determination unit 52a is configured to determine a three-dimensional rotation angle vector of the target object based on a product of the three-dimensional angular velocity vector and the inter-frame interval duration.

The processing unit 53a is configured to perform indexation processing on the three-dimensional rotation angle vector of the target object, to obtain a quaternion rotation angle vector of the target object.

The second determination unit 54a is configured to determine the quaternion rotation angle vector of the target object as the target rotation angle of the target object.

That the processing unit 53a performs indexation processing on the three-dimensional rotation angle vector of the target object, to obtain the quaternion rotation angle vector of the target object includes:
converting the three-dimensional rotation angle vector of the target object into a four-dimensional rotation angle vector; and
performing an operation with the four-dimensional rotation angle vector as an exponent and a natural constant as a base, to obtain the quaternion rotation angle vector of the target object.

That the processing unit 53a performs an operation with the four-dimensional rotation angle vector as an exponent and a natural constant as a base, to obtain the quaternion rotation angle vector of the target object includes:
performing modulo processing on the four-dimensional rotation angle vector, to obtain a real number angle of the target object;
performing unitization processing on the four-dimensional rotation angle vector, to obtain a unit four-dimensional rotation angle vector;
determining a product of the unit four-dimensional rotation angle vector and a sine value of the real number angle as a candidate rotation angle of the target object; and
determining a sum of the candidate rotation angle of the target object and a cosine value of the real number angle as the quaternion rotation angle vector of the target object.

The determination module 513 includes a second generation unit 55a, a third determination unit 56a, and a fourth determination unit 57a.

The second generation unit 55a is configured to generate a first quaternion direction vector reflecting the first direction parameter of the target object.

The third determination unit 56a is configured to determine a product of the first quaternion direction vector and the quaternion rotation angle vector corresponding to the target rotation angle as a second quaternion direction vector of the target object in the second game frame.

The fourth determination unit 57a is configured to determine the second quaternion direction vector as the second direction parameter of the target object in the second game frame.

The obtaining module 511 is configured to obtain a movement parameter of the target object and a first position of the target object in the first game frame.

The determination module 513 is further configured to determine a second position of the target object in the second game frame based on the movement parameter of the target object, the inter-frame interval duration, and the first position.

The forgoing apparatus further includes a rendering module 514.

The rendering module 514 is configured to render the target object based on the second position and the second direction parameter, to obtain a second game frame including the target object.

In some aspects, the determining, by the determination module 513, a second position of the target object in the second game frame based on the movement parameter of the target object, the inter-frame interval duration, and the first position of the target object in the first game frame includes:
determining a product of a movement speed in the movement parameter and the inter-frame interval duration as a movement distance of the target object; and
determining the second position of the target object in the second game frame based on a movement direction in the movement parameter, the movement distance, and the first position.

In some aspects, the rendering, by the rendering module 514, the target object based on the second position and the second direction parameter, to obtain a second game frame including the target object includes:
performing, if at least two target objects are provided, collision detection on the at least two target objects based on the second position corresponding to each of the at least two target objects, to obtain a detection result;
adjusting, based on the detection result, the second direction parameter corresponding to each of the at least two target objects, to obtain a third direction parameter corresponding to each of the at least two target objects; and
rendering the at least two target objects based on the third direction parameter and the second position corresponding to each of the at least two target objects, to obtain a second game frame including the at least two target objects.

In some aspects, the adjusting, by the rendering module 514 based on the detection result, the second direction parameter corresponding to each of the at least two target objects, to obtain a third direction parameter corresponding to each of the at least two target objects includes:
obtaining, if the detection result indicates that a first target object and a second target object of the at least two target objects collide with each other, an object category of the first target object and an object category of the second target object;
adjusting the second direction parameter of the first target object based on the object category of the first target object and the object category of the second target object, to obtain a third direction parameter of the first target object; and
adjusting the second direction parameter of the second target object based on the object category of the first target object and the object category of the second target object, to obtain a third direction parameter of the second target object.

According to an aspect of this disclosure, operations involved in the data processing method shown above may be performed by each module in the data processing apparatus shown in FIG. 5. For example, operation S101 shown in FIG. 3 may be performed by the obtaining module 511 shown in FIG. 5, and operation S102 shown in FIG. 3 may be performed by the processing module 512 shown in FIG. 5. Operation S103 shown in FIG. 3 may be performed by the determination module 513 shown in FIG. 5.

According to an aspect of this disclosure, the modules in the data processing apparatus shown in FIG. 5 may be separately or all combined into one or a plurality of units, or one (or more) of the units may be further split into at least two small subunits by function, which can implement the same operations without affecting the implementation of the technical effects of the aspects of this disclosure. The foregoing modules are divided based on logical functions. In an actual application, a function of one module may be implemented by at least two units, or functions of at least two modules are implemented by one unit. In other aspects of this disclosure, the data processing apparatus may further another unit. In practical application, these functions may also be implemented with the assistance of other units, and may be implemented with the assistance of at least two units.

According to an aspect of this disclosure, a computer program (including program code) that can perform the operations involved in the corresponding methods shown above may be run on a general-purpose computer device such as a computer including processing components such as a central processing unit (CPU) and storage components such as a random access storage medium (RAM) and a read-only storage medium (ROM), to construct the data processing apparatus shown in FIG. 5 and implement the data processing method in the aspects of this disclosure. The foregoing computer program may be recorded in, for example, a computer readable recording medium, and may be loaded into the foregoing computing device by using the computer readable recording medium, and run in the computing device.

In this disclosure, to enable a physics engine to represent an initial direction parameter (i.e., a first direction parameter of a rotating object in the first game frame), an inter-frame interval duration, and a rotation angular velocity of the rotating object (i.e., the target object), the initial direction parameter, the inter-frame interval duration, and the rotation angular velocity all fall within a range of numerical values controllable by the physics engine. When the initial direction parameter of the rotating object needs to be updated, the computer device may perform indexation processing on the rotation angular velocity of the rotating object by using the inter-frame interval duration between every two game frames (the first game frame and the second game frame), to obtain the target rotation angle of the target object. It may be learned based on the principle of the indexation processing that the indexation processing is equivalent to performing processing such as cosine calculation and sine calculation on a product of the rotation angular velocity and the inter-frame interval duration. It may be learned that indexation processing is performed on the rotation angular velocity by using the inter-frame interval duration, so that the target rotation angle obtained through the indexation processing can be limited in the range of numerical values controllable by the physics engine. Further, the updated direction parameter (i.e., the second direction parameter) of the rotating object that is determined and obtained based on the target rotation angle and the initial direction parameter of the rotating object also falls within the range of numerical values controllable by the physics engine. In other words, the updated direction parameter can be represented by the physics engine in the computer device, so as to avoid data overflow and a game interruption caused by the data overflow, thereby improving smoothness of the game.

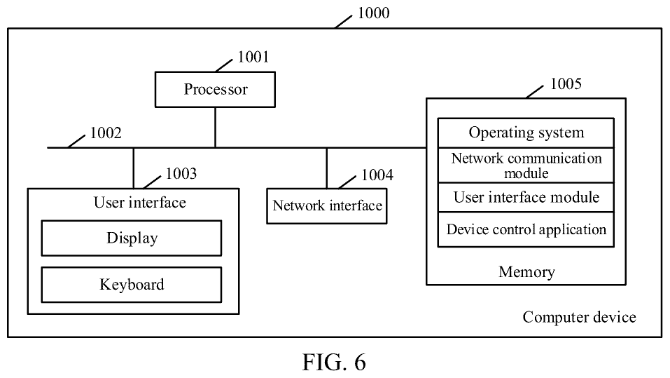

FIG. 6 is a schematic structural diagram of a computer device according to an aspect of this disclosure. As shown in FIG. 6, the foregoing computer device 1000 may be a first device in the foregoing method, and may specifically be a terminal or a server, including processing circuitry (for example, a processor 1001), a network interface 1004, and a memory 1005 (for example, a non-transitory computer-readable storage medium). In addition, the foregoing computer device 1000 may further include a user interface 1003 and at least one communication bus 1002. The communication bus 1002 is configured to implement connection and communication among the assemblies. In some aspects, the user interface 1003 may include a display and a keyboard. In some aspects, the user interface 1003 may further include a standard wired interface and wireless interface. In some aspects, the network interface 1004 may include a standard wired interface and a standard wireless interface (such as a Wi-Fi interface). The memory 1005 may be a high-speed RAM memory, or may be a non-volatile memory, for example, at least one disk memory. In some aspects, the memory 1005 may be at least one storage apparatus away from the foregoing processor 1001. As shown in FIG. 6, the memory 1005 used as a computer-readable storage medium may include an operating system, a network communication module, a user interface module, and a computer application.

In the computer device 1000 shown in FIG. 6, the network interface 1004 may provide a network communication function. The user interface 1003 is mainly configured to provide an input interface for a user. The processor 1001 may be configured to invoke the computer application stored in the memory 1005 to:
obtain a first direction parameter and a rotation angular velocity of a target object in a first game frame, and an inter-frame interval duration between the first game frame and a second game frame, a rendering order of the second game frame being after a rendering order of the first game frame;
perform indexation processing on the rotation angular velocity based on the inter-frame interval duration, to obtain a target rotation angle of the target object; and
determine a second direction parameter of the target object in the second game frame based on the target rotation angle and the first direction parameter of the target object.

In some aspects, that the processor 1001 may be configured to invoke the computer application stored in the memory 1005, so as to perform indexation processing on the rotation angular velocity based on the inter-frame interval duration, to obtain a target rotation angle of the target object includes:
generating a three-dimensional angular velocity vector of the target object based on the rotation angular velocity;
determining a three-dimensional rotation angle vector of the target object based on a product of the three-dimensional angular velocity vector and the inter-frame interval duration;
performing indexation processing on the three-dimensional rotation angle vector of the target object, to obtain a quaternion rotation angle vector of the target object; and
determining the quaternion rotation angle vector of the target object as the target rotation angle of the target object.

In some aspects, that the processor 1001 may be configured to invoke the computer application stored in the memory 1005, so as to perform indexation processing on the three-dimensional rotation angle vector of the target object, to obtain a quaternion rotation angle vector of the target object includes:
converting the three-dimensional rotation angle vector of the target object into a four-dimensional rotation angle vector; and
performing an operation with the four-dimensional rotation angle vector as an exponent and a natural constant as a base, to obtain the quaternion rotation angle vector of the target object.

In some aspects, that the processor 1001 may be configured to invoke the computer application stored in the memory 1005, so as to perform an operation with the four-dimensional rotation angle vector as an exponent and a natural constant as a base, to obtain the quaternion rotation angle vector of the target object includes:
performing modulo processing on the four-dimensional rotation angle vector, to obtain a real number angle of the target object;
performing unitization processing on the four-dimensional rotation angle vector, to obtain a unit four-dimensional rotation angle vector;
determining a product of the unit four-dimensional rotation angle vector and a sine value of the real number angle as a candidate rotation angle of the target object; and
determining a sum of the candidate rotation angle of the target object and a cosine value of the real number angle as the quaternion rotation angle vector of the target object.

In some aspects, that the processor 1001 may be configured to invoke the computer application stored in the memory 1005, so as to determine a second direction parameter of the target object in the second game frame based on the target rotation angle and the first direction parameter of the target object includes:
generating a first quaternion direction vector reflecting the first direction parameter of the target object;
determining a product of the first quaternion direction vector and the quaternion rotation angle vector corresponding to the target rotation angle as a second quaternion direction vector of the target object in the second game frame; and
determining the second quaternion direction vector as the second direction parameter of the target object in the second game frame.

In some aspects, the processor 1001 may be configured to invoke the computer application stored in the memory 1005 to:
obtain a movement parameter of the target object and a first position of the target object in the first game frame;
determine a second position of the target object in the second game frame based on the movement parameter of the target object, the inter-frame interval duration, and the first position; and
render the target object based on the second position and the second direction parameter, to obtain a second game frame including the target object.

In some aspects, that the processor 1001 may be configured to invoke the computer application stored in the memory 1005, so as to determine the second position of the target object in the second game frame based on the movement parameter of the target object, the inter-frame interval duration, and the first position of the target object in the first game frame includes:
determining a product of a movement speed in the movement parameter and the inter-frame interval duration as a movement distance of the target object; and
determining the second position of the target object in the second game frame based on a movement direction in the movement parameter, the movement distance, and the first position.

In some aspects, that the processor 1001 may be configured to invoke the computer application stored in the memory 1005, so as to render the target object based on the second position and the second direction parameter, to obtain a second game frame including the target object includes:
performing, if at least two target objects are provided, collision detection on the at least two target objects based on the second position corresponding to each of the at least two target objects, to obtain a detection result;
adjusting, based on the detection result, the second direction parameter corresponding to each of the at least two target objects, to obtain a third direction parameter corresponding to each of the at least two target objects; and
rendering the at least two target objects based on the third direction parameter and the second position corresponding to each of the at least two target objects, to obtain a second game frame including the at least two target objects.

In some aspects, that the processor 1001 may be configured to invoke the computer application stored in the memory 1005, so as to adjust the second direction parameter corresponding to each of the at least two target objects based on the detection result, to obtain a third direction parameter corresponding to each of the at least two target objects includes:
obtaining, if the detection result indicates that a first target object and a second target object of the at least two target objects collide with each other, an object category of the first target object and an object category of the second target object;
adjusting the second direction parameter of the first target object based on the object category of the first target object and the object category of the second target object, to obtain a third direction parameter of the first target object; and
adjusting the second direction parameter of the second target object based on the object category of the first target object and the object category of the second target object, to obtain a third direction parameter of the second target object.

In this disclosure, to enable a physics engine to represent an initial direction parameter (i.e., a first direction parameter of a rotating object in the first game frame), an inter-frame interval duration, and a rotation angular velocity of the rotating object (i.e., the target object), the initial direction parameter, the inter-frame interval duration, and the rotation angular velocity all fall within a range of numerical values controllable by the physics engine. When the initial direction parameter of the rotating object needs to be updated, the computer device may perform indexation processing on the rotation angular velocity of the rotating object by using the inter-frame interval duration between every two game frames (the first game frame and the second game frame), to obtain the target rotation angle of the target object. It may be learned based on the principle of the indexation processing that the indexation processing is equivalent to performing processing such as cosine calculation and sine calculation on a product of the rotation angular velocity and the inter-frame interval duration. It may be learned that indexation processing is performed on the rotation angular velocity by using the inter-frame interval duration, so that the target rotation angle obtained through the indexation processing can be limited in the range of numerical values controllable by the physics engine. Further, the updated direction parameter (i.e., the second direction parameter) of the rotating object that is determined and obtained based on the target rotation angle and the initial direction parameter of the rotating object also falls within the range of numerical values controllable by the physics engine. In other words, the updated direction parameter can be represented by the physics engine in the computer device, so as to avoid data overflow and a game interruption caused by the data overflow, thereby improving smoothness of the game.

The computer device in the aspects of this disclosure may perform the description of the foregoing data processing method in the aspects corresponding to the above, and may also perform the description of the foregoing data processing apparatus in the aspect corresponding to the above. Details are not described herein again. In addition, the description of beneficial effects of the same method are not described herein again.

In addition, an aspect of this disclosure further provides a computer-readable storage medium, such as a non-transitory computer-readable storage medium. The computer-readable storage medium has a computer program executed by the foregoing data processing apparatus stored therein. The computer program includes a program instruction. Upon executing the foregoing program instruction, the foregoing processor can perform the description of the data processing method in the foregoing aspects corresponding to the above. Therefore, details are not described herein again. In addition, the description of beneficial effects of the same method are not described herein again. For technical details that are not disclosed in the computer-readable storage medium aspects of this disclosure, reference can be made to the description of the method aspects of this disclosure.

In an example, the program instruction may be deployed to be executed on one computer device, or deployed to be executed on at least two computer devices at one site, or executed on at least two computer devices distributed at least two positions and connected by a communication network. The at least two computer devices distributed at the at least two positions and connected by the communication network can form a blockchain network.

The computer-readable storage medium may be the data processing apparatus according to any one of the foregoing aspects or a middle storage unit of the foregoing computer device, for example, a hard disk or a medium memory of the computer device. The computer-readable storage medium may alternatively be an external storage device of the computer device, for example, a plug-in hard disk, a smart media card (SMC), a secure digital (SD) card, and a flash card equipped on the computer device. Further, the computer-readable storage medium may further include both the central storage unit and the external storage device of the computer device. The computer-readable storage medium such as a non-transitory computer-readable storage medium is configured to store the computer program and another program and data required by the computer device. The computer-readable storage medium may be further configured to temporarily store data that has been outputted or that is to be outputted.

The terms such as “first” and “second” in the specification and claims of the aspects of this disclosure and the accompanying drawings are configured for distinguishing different medium contents, rather than being configured for describing a specific order. In addition, the term “include” and any variant thereof are intended to cover a non-exclusive inclusion. For example, a process, method, apparatus, product, or device that includes a series of operations or units is not limited to the listed operations or modules; and instead, in some aspects, further includes an operation or module that is not listed, or in some aspects, further includes another operation or unit that is intrinsic to the process, method, apparatus, product, or device.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An aspect of this disclosure further provides a computer program product, including a computer program/instruction. The computer program/instruction, when executed by a processor, implements the foregoing description of the foregoing data processing method and decoding method in the aspects corresponding to the above. Therefore, details are not described herein. In addition, the description of beneficial effects of the same method are not described herein again. For technical details that are not disclosed in the aspect of the computer program product involved in this disclosure, reference can be made to the description of the method aspect of this disclosure.

A person of ordinary skill in the art may realize that operations of units and algorithms of various examples described with reference to the aspects disclosed in this specification can be implemented in electronic hardware, computer software or a combination of the electronic hardware and the computer software. To describe the interchangeability of hardware and software, the compositions and operations of the various examples have been described in terms of functionality in the foregoing description. Whether the functions are executed by hardware or software depends on specific applications and design constraint conditions of the technical solutions. A person skilled in the art may use different methods to implement the described functions for each specific application, but it is not to be considered that the implementation goes beyond the scope of this disclosure.

The method and the related apparatus provided in the aspects of this disclosure are described with reference to the method flowcharts and/or schematic structural diagrams provided in the aspects of this disclosure. Specifically, each process and/or block in the method flowchart and/or the schematic structural diagram and a combination of the process and/or the block in the flowchart and/or the block diagram may be implemented by a computer program instruction. These computer program instructions may be provided to a processor of a general-purpose computer, a special-purpose computer, an embedded processing machine, or another programmable network-connected device to generate a machine, so that instructions executed by the processor of the computer or the another programmable network-connected device generate an apparatus for implementing functions specified in one or more processes of the flowcharts and/or one or more blocks of the schematic structural diagrams. These computer program instructions may alternatively be stored in a computer-readable memory that can direct the computer or the another programmable network connection device to operate in such a way that the instructions stored in the computer-readable memory generate an article of manufacture including an instruction apparatus which implements the functions specified in one or more processes of the flowcharts and/or one or more blocks of the schematic structural diagrams. These computer program instructions may alternatively be loaded onto the computer or the another programmable network-connected device, so that a series of operations are performed on the computer or the another programmable device, thereby generating computer-implemented processing. Therefore, the instructions executed on the computer or the another programmable device provide operations for implementing the specific functions in one or more processes in the flowcharts and/or in one or more blocks in the block diagrams.

What is disclosed above are merely examples of aspects of this disclosure, and is not intended to limit the scope of this disclosure. Therefore, equivalent variations shall fall within the scope of this disclosure.

What is claimed is:

1. A data processing method, comprising:
obtaining a first direction parameter and a rotation angular velocity of a target object in a first game frame, and an inter-frame interval duration between the first game frame and a second game frame, the second game frame being rendered after the first game frame;
obtaining a target rotation angle of the target object based on the rotation angular velocity and the inter-frame interval duration; and
determining a second direction parameter of the target object in the second game frame based on the target rotation angle and the first direction parameter.

2. The method according to claim 1, wherein the obtaining the target rotation angle comprises:
generating a three-dimensional angular velocity vector of the target object based on the rotation angular velocity;
determining a three-dimensional rotation angle vector of the target object based on a product of the three-dimensional angular velocity vector and the inter-frame interval duration;
obtaining a quaternion rotation angle vector of the target object based on the three-dimensional rotation angle vector of the target object; and
determining the quaternion rotation angle vector as the target rotation angle of the target object.

3. The method according to claim 2, wherein the obtaining the quaternion rotation angle vector comprises:
converting the three-dimensional rotation angle vector of the target object into a four-dimensional rotation angle vector; and
performing an operation with the four-dimensional rotation angle vector as an exponent and a natural constant as a base to obtain the quaternion rotation angle vector of the target object.

4. The method according to claim 3, wherein the performing the operation with the four-dimensional rotation angle vector comprises:
performing modulo processing on the four-dimensional rotation angle vector, to obtain a real number angle of the target object;
performing unitization processing on the four-dimensional rotation angle vector to obtain a unit four-dimensional rotation angle vector;
determining a product of the unit four-dimensional rotation angle vector and a sine value of the real number angle as a candidate rotation angle of the target object; and
determining a sum of the candidate rotation angle of the target object and a cosine value of the real number angle as the quaternion rotation angle vector of the target object.

5. The method according to claim 2, wherein the determining the second direction parameter of the target object comprises:
generating a first quaternion direction vector reflecting the first direction parameter of the target object;
determining a product of the first quaternion direction vector and the quaternion rotation angle vector corresponding to the target rotation angle as a second quaternion direction vector of the target object in the second game frame; and
determining the second quaternion direction vector as the second direction parameter of the target object in the second game frame.

6. The method according to claim 1, further comprising:
obtaining a movement parameter of the target object and a first position of the target object in the first game frame;
determining a second position of the target object in the second game frame based on the movement parameter, the inter-frame interval duration, and the first position; and
rendering the target object based on the second position and the second direction parameter to obtain the second game frame including the target object.

7. The method according to claim 6, wherein the determining the second position of the target object comprises:
determining a product of a movement speed in the movement parameter and the inter-frame interval duration as a movement distance of the target object; and
determining the second position of the target object based on a movement direction in the movement parameter, the movement distance, and the first position.

8. The method according to claim 6, wherein the rendering the target object comprises:
when at least two target objects are provided, performing collision detection on the at least two target objects based on respective second positions of the at least two target objects to obtain a detection result;
adjusting, based on the detection result, the second direction parameter of each of the at least two target objects to obtain respective third direction parameters; and
rendering the at least two target objects based on the respective third direction parameters and the respective second positions to obtain the second game frame.

9. The method according to claim 8, wherein the adjusting the second direction parameter comprises:
when the detection result indicates that a first target object and a second target object of the at least two target objects collide with each other, obtaining an object category of the first target object and an object category of the second target object;
adjusting the second direction parameter of the first target object based on the object category of the first target object and the object category of the second target object to obtain a third direction parameter of the first target object; and
adjusting the second direction parameter of the second target object based on the object category of the first target object and the object category of the second target object to obtain a third direction parameter of the second target object.

10. A data processing apparatus, comprising:
processing circuitry configured to:
obtain a first direction parameter and a rotation angular velocity of a target object in a first game frame, and an inter-frame interval duration between the first game frame and a second game frame, the second game frame being rendered after the first game frame;
obtain a target rotation angle of the target object based on the rotation angular velocity and the inter-frame interval duration; and
determine a second direction parameter of the target object in the second game frame based on the target rotation angle and the first direction parameter.

11. The apparatus according to claim 10, wherein the processing circuitry is configured to:
generate a three-dimensional angular velocity vector of the target object based on the rotation angular velocity;
determine a three-dimensional rotation angle vector of the target object based on a product of the three-dimensional angular velocity vector and the inter-frame interval duration;
obtain a quaternion rotation angle vector of the target object based on the three-dimensional rotation angle vector of the target object; and
determine the quaternion rotation angle vector as the target rotation angle of the target object.

12. The apparatus according to claim 11, wherein the processing circuitry is configured to:
convert the three-dimensional rotation angle vector of the target object into a four-dimensional rotation angle vector; and
perform an operation with the four-dimensional rotation angle vector as an exponent and a natural constant as a base to obtain the quaternion rotation angle vector of the target object.

13. The apparatus according to claim 12, wherein the processing circuitry is configured to:
perform modulo processing on the four-dimensional rotation angle vector, to obtain a real number angle of the target object;
perform unitization processing on the four-dimensional rotation angle vector to obtain a unit four-dimensional rotation angle vector;
determine a product of the unit four-dimensional rotation angle vector and a sine value of the real number angle as a candidate rotation angle of the target object; and
determine a sum of the candidate rotation angle of the target object and a cosine value of the real number angle as the quaternion rotation angle vector of the target object.

14. The apparatus according to claim 11, wherein the processing circuitry is configured to:
generate a first quaternion direction vector reflecting the first direction parameter of the target object;
determine a product of the first quaternion direction vector and the quaternion rotation angle vector corresponding to the target rotation angle as a second quaternion direction vector of the target object in the second game frame; and
determine the second quaternion direction vector as the second direction parameter of the target object in the second game frame.

15. The apparatus according to claim 10, wherein the processing circuitry is configured to:
obtain a movement parameter of the target object and a first position of the target object in the first game frame;
determine a second position of the target object in the second game frame based on the movement parameter, the inter-frame interval duration, and the first position; and
render the target object based on the second position and the second direction parameter to obtain the second game frame including the target object.

16. The apparatus according to claim 15, wherein the processing circuitry is configured to:
determine a product of a movement speed in the movement parameter and the inter-frame interval duration as a movement distance of the target object; and
determine the second position of the target object based on a movement direction in the movement parameter, the movement distance, and the first position.

17. The apparatus according to claim 15, wherein the processing circuitry is configured to:
when at least two target objects are provided, perform collision detection on the at least two target objects based on respective second positions of the at least two target objects to obtain a detection result;
adjust, based on the detection result, the second direction parameter of each of the at least two target objects to obtain respective third direction parameters; and
render the at least two target objects based on the respective third direction parameters and the respective second positions to obtain the second game frame.

18. The apparatus according to claim 17, wherein the processing circuitry is configured to:
when the detection result indicates that a first target object and a second target object of the at least two target objects collide with each other, obtain an object category of the first target object and an object category of the second target object;
adjust the second direction parameter of the first target object based on the object category of the first target object and the object category of the second target object to obtain a third direction parameter of the first target object; and
adjust the second direction parameter of the second target object based on the object category of the first target object and the object category of the second target object to obtain a third direction parameter of the second target object.

19. A non-transitory computer-readable storage medium storing instructions which, when executed by a processor, cause the processor to perform:
obtaining a first direction parameter and a rotation angular velocity of a target object in a first game frame, and an inter-frame interval duration between the first game frame and a second game frame, the second game frame being rendered after the first game frame;
obtaining a target rotation angle of the target object based on the rotation angular velocity and the inter-frame interval duration; and
determining a second direction parameter of the target object in the second game frame based on the target rotation angle and the first direction parameter.

20. The non-transitory computer-readable storage medium according to claim 19, wherein the obtaining the target rotation angle comprises:
generating a three-dimensional angular velocity vector of the target object based on the rotation angular velocity;
determining a three-dimensional rotation angle vector of the target object based on a product of the three-dimensional angular velocity vector and the inter-frame interval duration;
obtaining a quaternion rotation angle vector of the target object based on the three-dimensional rotation angle vector of the target object; and
determining the quaternion rotation angle vector as the target rotation angle of the target object.
